(19) United States
(12) Patent Application Publication
(10) Pub. No.: US 2024/0304203 A1
(43) Pub. Date: Sep. 12, 2024

(54) NOISE REDUCTION USING VOICE ACTIVITY DETECTION IN AUDIO PROCESSING SYSTEMS AND APPLICATIONS

(71) Applicant: NVIDIA Corporation, Santa Clara, CA (US)

(72) Inventors: Suchitra Mandar Joshi, Pune (IN); Mihir Manohar Nyayate, Pune (IN); Ambrish Dantrey, Pune (IN)

(21) Appl. No.: 18/117,717

(22) Filed: Mar. 6, 2023

(51) Int. Cl. G10L 21/0232; G10L 25/51; G10L 25/78

(52) U.S. Cl. CPC G10L 21/0232; G10L 25/51; G10L 25/78

(57) ABSTRACT

In various examples, a noise reduction may be performed based at least on determining that audio data encoding sound includes undesirable sound or lacks desirable sound. A frequency is determined for audio data based at least on value(s) associated with frequency(ies) within a frequency band and used to determine that sound encoded in the audio data includes undesirable sound or lacks desirable sound.

### FIELD

At least one embodiment pertains to methods and/or systems for noise reduction using voice activity detection in audio processing systems and applications. For example, at least one embodiment pertains to identifying and reducing noise detected in audio data using various novel techniques described herein.

### BACKGROUND

Audio data-such as sounds and speech—may be captured and transmitted to one or more devices for playback or presentation by a computing device, mobile device, and/or gaming device. Example applications include multimedia (video and audio) streaming, music or audio (e.g., podcast) streaming, and gaming applications. Such audio data often includes one or more desired portions capturing human vocalization, speech, and/or spoken sound. Unfortunately, the recorded audio data may also include one or more undesired portions that include additional sound or noise that is unintentionally captured by an audio device, such as a microphone. When present, the undesired portion(s) may interfere with, obscure, and/or distract from the desired portion(s) (e.g., speech), causing a loss in perceived audio quality and/or clarity that may make it difficult for a recorded speaker and their vocalizations to be clearly heard and/or understood.

Some conventional techniques for background noise removal analyze one or more waveforms included in audio data to identify audio data associated with speech and/or audio data associated with background noise, so that the background noise may be attenuated or removed, leaving only the audio data relating to speech. Unfortunately, such conventional techniques are computationally demanding and exhibit latency unsuitable for streaming audio data. Further, during periods of an audio recording when there is low volume or no speech, or an extended period of relative silence, conventional techniques may have difficulty accurately distinguishing background noise from speech so that the noise can be accurately removed while ensuring that speech audio is not inadvertently eliminated (e.g., dropped and/or clipped).

### BRIEF DESCRIPTION OF THE DRAWINGS

The present systems and methods for noise reduction using voice activity detection in audio processing systems and applications are described in detail below with reference to the attached drawing figures, wherein:

FIG. 1 is a diagram of an example of an example noise reduction system, in accordance with some embodiments of the present disclosure;

FIG. 2 is a diagram showing an example process for noise reduction, in accordance with some embodiments of the present disclosure;

FIG. 3 is a diagram showing an example of a noisy audio spectrogram, in accordance with some embodiments of the present disclosure;

FIG. 4 is a diagram showing an example of a denoised spectrogram, in accordance with some embodiments of the present disclosure;

FIG. 5 is a flow diagram showing a method for performing a multiple band voice detection operation, in accordance with some embodiments of the present disclosure;

FIG. 6 is a flow diagram showing a method for performing a voice detection operation, in accordance with some embodiments of the present disclosure;

FIG. 7 is a block diagram of an example game streaming system suitable for use in implementing some embodiments of the present disclosure; and

FIG. 8 is a block diagram of an example computing device suitable for use in implementing some embodiments of the present disclosure.

### DETAILED DESCRIPTION

Embodiments of the present disclosure relate to noise reduction using voice activity detection in audio processing systems and applications. Systems and methods are disclosed that use a voice activity detector to analyze sound in the frequency domain, detect time periods during which there is no voice activity, and eliminate sound(s) from those time periods. In contrast to conventional systems, such as those described above, the voice activity detector may eliminate noise occurring during extended periods of silence and/or periods of low or no speech activity. Further, such noise may be eliminated without dropping data associated with speech.

Systems and methods are disclosed related to voice activity detection for noise reduction. According to one or more embodiments, the audio noise reduction technique may use a feature exactor, one or more machine learning models, the voice activity detector, and a time-frequency converter. The feature exactor may extract one or more parameters from a stream of audio data and use those parameter(s) to obtain one or more features that may be used to obtain input data, such as an audio spectrogram, a mel-frequency spectrogram, and/or the like. For example, the parameter(s), such as sound pressure (e.g., volume) of the frequencies, may be extracted from a stream of audio data and used to obtain the features, such as audio signal power and/or intensity (which is power per unit area) for the frequencies. Then, the features may be used to obtain input data (e.g., mel-frequency coefficients). By way of a non-limiting example, a stream of audio data (e.g., mono channel noisy audio data, such as noisy speech data) may be sampled according to a sampling rate (e.g., 48 kHz, etc.) to generate the input data (e.g., a mel-frequency spectrogram that includes one or more bins that correspond to one or more ranges of mel-frequencies). The feature exactor may provide the input data to the machine learning model(s).

The machine learning model(s) process(es) the input data to generate a noise mask and/or a speech mask. The noise and speech masks may be used to suppress noise and speech, respectively, in the audio data. For example, the machine learning model(s) may process one or more time-bands of a mel-frequency spectrogram (e.g., generated by the feature extractor) to generate a noise mask for a center time-band of the spectrogram with one or more frequency bins in a frequency domain. Then, a post-processing module may be used to invert the noise mask into the speech mask that may be used to isolate speech within noisy audio. The post-processing module may use the noise mask and/or the speech mask to remove noise from the audio data to produce processed input data. For example, the post-processing module may multiply the noise mask with a short-time Fourier transform (“STFT”) spectrogram of the input audio data to obtain a processed time-frequency representation (e.g., spectrogram) of audio data without one or more noise features. In at least one embodiment, the processed time-frequency representation of the audio data may be provided to the voice activity detector (as the processed input data) for additional noise reduction.

The voice activity detector may remove additional noise (e.g., undesirable sound) from the processed input data (e.g., the processed time-frequency representation) by eliminating sound(s) from periods during which no voice activity is detected. Detecting voice activity may include identifying one or more speech conditions in audio data that may indicate the presence of voice activity. For example, a mean (e.g., or other central tendency) frequency (e.g., based on audio signal power and/or intensity value) of one or more frequency bands for a particular instance of time may be calculated and compared to a threshold value to determine whether speech is detected. For example, if the mean frequency of a lower frequency band is lower than a first threshold value, the audio data for that instance of time may be identified as having no voice activity (e.g., noise). In such an example, if the mean frequency of the lower frequency band is greater than the first threshold value, the audio data for that instance of time may be identified as having voice activity.

The voice activity detector may evaluate multiple frequency bands of a frequency spectrum. For example, the voice activity detector may collectively and/or individually analyze the lower frequency band and/or a higher frequency band to detect voice activity. The lower frequency band may be defined as a lower half of a particular frequency spectrum (e.g., a frequency spectrum representing audio data) based on a middle frequency value. By way of another non-limiting example, the higher frequency band may be defined as a higher half of a particular frequency spectrum based on a middle frequency value. However, the lower and/or higher frequency bands may each be defined to include any one or more ranges of frequencies represented in a frequency spectrum.

The voice activity detector may analyze one or more frequency ranges to detect voice activity corresponding to different voicings and/or sounds of speech. For example, in the English language, audio data representing sound corresponding to the voicing of some sounds, such as letters “s” and “f,” may have an associated frequency spectrum with a higher intensity in an upper frequency band while having a lower intensity in a lower frequency band. In such an example, the higher frequency band may be analyzed independently from the lower frequency band, to detect voice activity associated with particular speech sounds. The voice activity detector may calculate a mean (e.g., or other central tendency) frequency (e.g., based on audio signal power and/or intensity value) of the higher frequency band for a particular instance of time, and compare the mean frequency of the higher frequency band to a second threshold value to determine whether speech is detected. For example, if the mean frequency of the higher frequency band is lower than the second threshold value for the higher frequency band, the audio data for that instance of time may be identified as having no voice activity. In such an example, if the mean frequency of the higher frequency band is greater than the second threshold value for the higher frequency band, the audio data for that instance of time may be identified as having voice activity.

When the voice activity detector identifies voice activity in a time-frequency representation of audio data during an instance of time at one or more frequencies of a frequency spectrum (e.g., in one or more frequency bands), the audio data associated with the corresponding frequencies may be retained, or otherwise preserved. On the other hand, when the voice activity detector does not identify voice activity in a time-frequency representation of audio data during an instance of time at one or more frequencies of a frequency spectrum (e.g., in one or more frequency bands), the audio data associated with the corresponding frequencies may be reduced and/or removed (e.g., value modified to 0) to generate an updated spectrogram with noise removed. For example, any non-zero intensities at the instance of time in the time-frequency representation (e.g., the spectrogram) may be adjusted (e.g., reduced, set to zero, and/or the like) to generate the updated spectrogram. Thus, sound values (e.g., sound pressure, intensity, and/or audio signal power) of the corresponding frequencies may be adjusted (e.g., reduced, set to zero, and/or the like) at the instance of time.

Once the updated spectrogram has been generated by the voice activity detector, the time-frequency converter may convert the updated spectrogram representing audio data to a time domain signal. For example, the time-frequency converter may use an inverse Fourier transform (e.g., an inverse short-term Fourier transform (“ISTFT”)) to convert the updated spectrogram from the frequency domain to time domain. The inverse Fourier transform may be modified to support input data arriving in a streaming fashion.

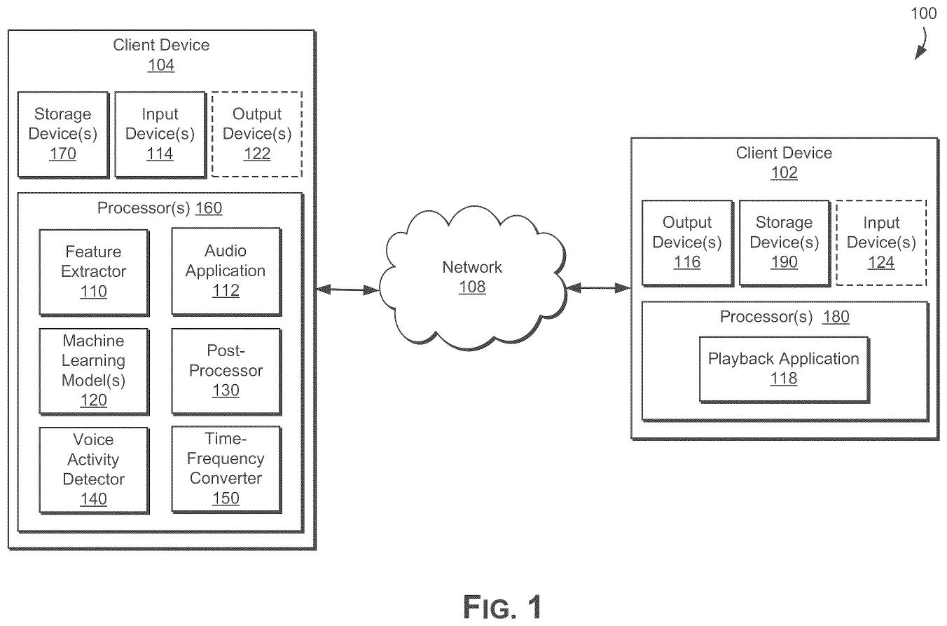

With reference to FIG. 1, FIG. 1 is an example noise reduction system 100 (or “system 100”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

System 100 may include one or more client devices, such as a client device 102 and/or a client device 104. Each of the client device(s) may be implemented as a computing system, such as a personal computer, a telephony device (e.g., a cellular telephone), a game console, and/or the like. Client devices 102 and 104 may communicate with one another over a network 108 using digital communications.

Client device 104 may include one or more input devices 114, one or more optional output devices 122, converter 150, one or more processors 160, and/or one or more storage devices 170. Input device(s) 114, optional output device(s) 122, processor(s) 160, and storage device(s) 170 may communicate with one another over a connection (not shown), such as a bus. Input device(s) 114 may be implemented using a microphone and/or other audio capture device. In at least one embodiment, input device(s) 114 may be part of a headset of a computing device (e.g., client device 104). Optional output device(s) 122 may be implemented using one or more speakers, and/or the like. The processor(s) 160 may be implemented, for example, using a main central processing unit (“CPU”) complex, one or more microprocessors, one or more microcontrollers, one or more graphics processing units (“GPU(s)”), one or more data processing units (“DPU(s)”), and/or the like. Storage device(s) 170 may include memory (e.g., one or more non-transitory processor-readable medium) storing processor executable instructions that when executed by processor(s) 160 of client device 104 implement a feature extractor 110, an audio application 112, one or more machine learning models 120, a post-processor 130, a voice activity detector 140, and/or a time-frequency converter 150. By way of additional non-limiting examples, the memory (e.g., one or more non-transitory processor-readable medium) may be implemented, for example, using volatile memory (e.g., dynamic random-access memory (“DRAM”)) and/or nonvolatile memory (e.g., a hard drive, a solid-state device (“SSD”), and/or the like).

Audio application 112 may cause input device(s) 114 to capture a stream of audio data. Audio application 112 may include and/or have access to feature extractor 110, machine learning model(s) 120, post-processor 130, voice activity detector 140, and/or time-frequency converter 150. Audio application 112 may provide the stream of audio data to feature extractor 110.

Feature extractor 110 may extract one or more parameters from the stream of audio data and use those parameter(s) to obtain one or more features that may be used to obtain input data, such as an audio spectrogram, a mel-frequency spectrogram, and/or the like. Feature extractor 110 may provide the input data to machine learning model(s) 120. For example, audio application 112 may instruct feature extractor 110 to provide the input data to machine learning model(s) 120.

Machine learning model(s) 120 process(es) the input data to generate a noise mask and/or a speech mask. Machine learning model(s) 120 may provide the noise mask and/or the speech mask to post-processor 130. For example, audio application 112 may instruct machine learning model(s) 120 to provide the noise mask and/or the speech mask to post-processor 130.

Post-processor 130 may use the noise mask and/or the speech mask to remove noise from the audio data to produce processed input data (e.g., a processed spectrogram) that post-processor 130 provides to voice activity detector 140 for additional noise reduction. For example, audio application 112 may instruct post-processor 130 to provide the processed input data to voice activity detector 140.

Voice activity detector 140 may perform one or more noise reduction operations on the processed input data to generate an updated spectrogram and provide the updated spectrogram to time-frequency converter 150. For example, audio application 112 may instruct voice activity detector 140 to provide the updated spectrogram to time-frequency converter 150.

Time-frequency converter 150 may convert the updated spectrogram to a time domain signal. The client device 104 may transmit the time domain signal to client device 102. Optionally, the time domain signal may be encoded before being transmitted to client device 102. For example, audio application 112 may receive the time domain signal from time-frequency converter 150, optionally encode the time domain signal, and transmit the time domain signal to the client device 102.

Client device 102 may receive the time domain signal and playback the time domain signal to the first user(s). Client device 102 may include one or more of output device(s) 116, optional input device(s) 124, processor(s) 180, and/or storage device(s) 190. Output device(s) 116, optional input device(s) 124, processor(s) 180, and storage device(s) 190 may communicate with one another over a connection (not shown), such as a bus. Output device(s) 116 may be implemented using any component suitable for implementing the optional output device(s) 122. Optional input device(s) 124 may be implemented using any component suitable for implementing the input device(s) 114. The processor(s) 180 may be implemented, for example, using a main CPU complex, one or more microprocessors, one or more microcontrollers, one or more GPU(s), one or more DPU(s), and/or the like. Storage device(s) 190 may include memory (e.g., one or more non-transitory processor-readable medium) storing processor executable instructions that when executed by processor(s) 180 of client device 102 implement a playback application 118. By way of additional non-limiting examples, the memory (e.g., one or more non-transitory processor-readable medium) may be implemented, for example, using volatile memory (e.g., DRAM) and/or nonvolatile memory (e.g., a hard drive, a SSD, and/or the like).

Playback application 118 may cause output device(s) 116 to playback the time domain signal output by time-frequency converter 150 and transmitted to the client device 102.

Components of system 100 may communicate across one or more networks, such as network 108 and/or other network types described herein. Network 108 may include one or more networks of any number of network types. In some examples, network 108 may include a cellular network and/or the Internet.

In at least one embodiment, audio data may be processed to determine and remove noise using system 100. In at least one embodiment, a first user (or users) may operate client device 102 to communicate using digital communications with a second user (or users) operating the client device 104, such as during a teleconference and/or in an online gaming setting. In at least one embodiment, input device(s) 114 may capture speech or other utterances produced by a person (e.g., second user(s)). In at least one embodiment, input device(s) 114 capture(s) speech or other audio data and provide(s) the captured speech to client device 104, which may produce a digital audio signal that may be propagated over network 108. In at least one embodiment, this digital audio signal may be received by another client device 102, which may cause this digital audio signal to be presented, using playback application 118, to the first user(s) using at least one output device(s) 116, such as may be part of a headset, audio speaker, and/or other suitable presentation mechanism. In at least one embodiment, the optional input device(s) 124 may be used to capture speech uttered by the first user(s) operating client device 102 and present that speech through the optional output device(s) 122 (e.g., one or more speakers) to the second user(s) operating client device 104.

In at least one embodiment, there may be additional audio or sounds captured by input device(s) 114. In at least one embodiment, this additional audio may be separate from speech of the second user(s) and undesirable to present to the first user(s) as this additional audio may degrade quality and/or clarity of captured speech. In at least one embodiment, noise may include any type of audible signal or sound that does not correspond to primary audio, such as speech of a participant in a teleconference. In at least one embodiment, noise may include sounds such as computer fans, keyboard typing, mouse click sounds, wind, engine noise, rain hitting a surface, crowd noise or people chatter, tapping, clapping, a baby crying, or cooking sounds, which may negatively impact clarity of speech contained in an audio signal.

In at least one embodiment, audio application 112 executing on client device 104 may attempt to improve a quality of speech, or other primary audio, contained in a digital audio signal before transmitting that digital audio signal to client device 102 for presentation (e.g., providing playback through at least one output device(s) 116 to the first user(s)). In at least one embodiment, audio application 112 may alternatively be executing on client device 102 to enhance received audio, or may execute in a cloud environment or on a third party device for purposes of enhancing audio quality to be transmitted or presented.

In at least one embodiment, audio application 112 executing on client device 104 may cause a stream of input audio data to be provided as input to feature extractor 110, which may extract one or more parameters from the stream of input audio data. In at least one embodiment, the stream of input audio data may include human speech. In at least one embodiment, feature extractor 110 may output a set of features in a format such as an audio spectrogram, or mel-frequency spectrogram, and/or the like. In at least one embodiment, this audio spectrogram may be provided as input to machine learning model(s) 120, such as may correspond to one or more neural networks trained to predict a presence in input audio of various types of noise.

In at least one embodiment, machine learning model(s) 120 outputs a noise signal or audio mask, and provides the noise signal or audio mask as input to post-processor 130. In at least one embodiment, post-processor 130 may subtract the noise signal (e.g., audio mask) from an input audio signal (e.g., the stream of input audio data) to produce an output audio signal without sound that is present in the noise signal. In at least one embodiment, the output audio signal is substantially free of noise and contains primarily clean speech or other primary audio. In at least one embodiment, this involves post-processor 130 inverting the audio mask (e.g., the noise signal) output by machine learning model(s) 120 and applying this inverted mask to the input audio signal (e.g., the stream of input audio data) to effectively remove detected noise from this input audio signal. In at least one embodiment, feature extractor 110 and machine learning model(s) 120 may involve one or more neural network-based tasks executed on one or more GPUs. In at least one embodiment, post-processing may execute on one or more GPUs and/or a CPU. In at least one embodiment, other types of post-processing may be applied as well, such as to adjust a format of an audio signal for playback. In at least one embodiment, this output audio signal may then be transmitted for presentation, by playback application 118, through output device(s) 116 or another playback mechanism. In at least one embodiment, removing noise before transmission may avoid issues with audio encoding. In at least one embodiment, such a pipeline may be used to remove noise from audio signals containing various types of primary audio. In at least one embodiment, primary audio such as music or audio communication may be enhanced by removing background noise using such a system.

Feature extractor 110 may include one or more components to extract one or more features from a stream of audio data and output input data having a format such as an audio spectrogram, or a mel-frequency spectrogram, and/or the like. The input data, such as mel-frequency coefficients, may be obtained from feature(s) extracted from a stream of audio data using feature extractor 110. For example, feature extractor 110 may sample a stream of audio data (e.g., mono channel noisy audio data, such as noisy speech data) according to a sampling rate (e.g., 48 kHz, etc.) to generate a mel-frequency spectrogram that includes one or more bins that correspond to one or more ranges of mel-frequencies. In at least one embodiment, feature extractor 110 may generate a mel-frequency spectrogram from a stream of audio data by processing overlapping (e.g., 50% overlap, 75% overlap, etc.) segments each including a number of samples (e.g., 2048 samples) taken from the stream of audio data (e.g., mono channel noisy audio data, such as noisy speech data). In at least one embodiment, to enable support for streaming, feature extractor 110 may sample a limited number of samples (e.g., 512 samples) from an incoming audio stream over a number of iterations (e.g., to obtain segments each having 512 samples and/or to combine samples obtained from two or more iterations to create segments each including more than 512 samples). In at least one embodiment, samples of a past number of iterations (e.g., three) are retrieved from a cache, or other temporary storage location, which contribute to an overlapped portion. In at least one embodiment, feature extractor 110 computes a one time-band of a mel-frequency spectrogram by combining overlapping portions of audio data segments. In at least one embodiment, feature extractor 110 may provide this time band from this mel-frequency spectrogram to machine learning model(s) 120 along with a number (e.g., six) of past time bands from this buffer.

Machine learning model(s) 120 may process the input data generated by feature extractor 110 and generate a noise mask and/or a speech mask. Machine learning model(s) 120 may include one or more components to process one or more time-bands of a mel-frequency spectrogram (e.g., generated by feature extractor 110) to generate a noise mask for a center time-band of the mel-frequency spectrogram with one or more frequency bins in a frequency domain. In at least one embodiment, a speech mask is an audio mask that suppresses speech in audio data, and a noise mask is an audio mask that suppresses noise in audio data.

In at least one embodiment, machine learning model(s) 120 may include one or more neural networks trained to generate a noise mask and/or a speech mask associated with noisy audio represented by audio data from input data generated by feature extractor 110. For example, the machine learning model(s) 120 may process one or more time-bands of a mel-frequency spectrogram (e.g., generated by feature extractor 110) to generate a noise mask for a center time-band of the spectrogram with one or more frequency bins in a frequency domain. In some embodiments, machine learning model(s) 120 may be used to learn temporal and/or spatial features represented in an audio signal, such as fundamental frequencies, speech, harmonics, various noise patterns, and/or any other suitable feature. In at least one embodiment, one or more output filters may be applied to assist machine learning model(s) 120 in identifying additional features represented in audio data. In at least one embodiment, machine learning model(s) 120 may isolate noise and speech features and construct an audio mask that may suppress the noise or speech features.

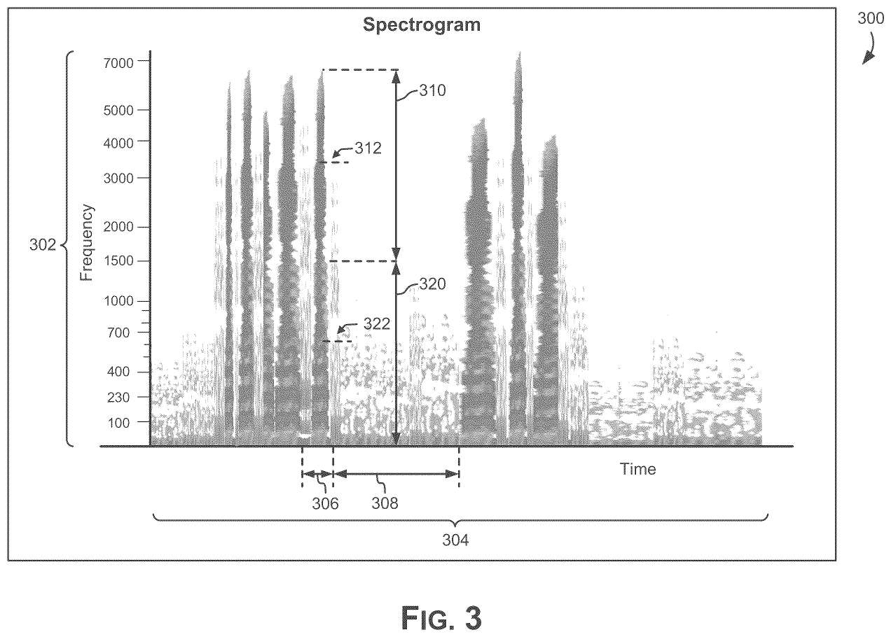

Post-processor 130 may include one or more components to perform one or more operations on one or more audio masks generated using machine learning model(s) 120. In at least one embodiment, post-processor 130 may invert a speech mask, generated by machine learning model(s) 120, into a noise mask, which isolates speech from input noisy audio. For example, a noise mask may be normalized to have values ranging from 0 to 1, with each value being a difference calculated as 1.0 minus a corresponding value from a speech mask. In at least one embodiment, post-processor 130 may multiply a generated noise mask with a short-time Fourier transform (“STFT”) spectrogram of input audio to obtain a processed time-frequency representation (e.g., spectrogram) of audio data without one or more noise features. In at least one embodiment, the processed time-frequency representation (e.g., noisy audio spectrogram 300 of FIG. 3) of audio data may be provided to voice activity detector 140 for additional noise reduction.

Voice activity detector 140 may include one or more components to remove additional noise from a processed input data (e.g., the processed time-frequency representation). In at least one embodiment, voice activity detector 140 may identify one or more speech conditions in audio data that may indicate the presence of voice activity. For example, voice activity detector 140 may calculate a mean (e.g., or other central tendency) frequency (e.g., based on one or more properties, such as audio signal power and/or intensity, of the audio data) of one or more frequency bands for a particular instance of time and compare the frequency to a threshold value to determine whether speech is detected. For example, if the mean frequency of a lower frequency band is lower than a threshold value, the audio data for that instance of time may be identified by voice activity detector 140 as having no voice activity (e.g., as being noise). In such an example, if the mean frequency of the lower frequency band is greater than the threshold value for that frequency band, the audio data for that instance of time may be identified as having voice activity.

In at least one embodiment, voice activity detector 140 may evaluate multiple frequency bands of a frequency spectrum. For example, voice activity detector 140 may collectively and/or individually analyze a lower frequency band and/or a higher frequency band to detect voice activity. In at least one embodiment, a lower frequency band may be defined as a lower half of a particular frequency spectrum (e.g., a frequency spectrum representing audio data) based on a middle frequency value. In at least one embodiment, a higher frequency band may be defined as a higher half of a particular frequency spectrum based on a middle frequency value. In at least one embodiment, lower and/or higher frequency bands may be defined to include any one or more ranges of frequencies represented in a frequency spectrum.

In at least one embodiment, voice activity detector 140 may analyze one or more frequency ranges to detect voice activity corresponding to different voicings and/or sounds of speech. As stated herein, audio data representing sound corresponding to the voicing of some sounds (e.g., letters “s” and “f,” in the English language) may have an associated frequency spectrum with a higher intensity in an upper frequency band while having a lower intensity in a lower frequency band. In such an example, voice activity detector 140 may analyze the higher frequency band independently from the lower frequency band, to detect voice activity associated with particular speech sounds. In at least one embodiment, voice activity detector 140 may calculate a mean (e.g., or other central tendency) frequency (e.g., based on one or more properties, such as audio signal power and/or intensity value, of the audio data) of the higher frequency band for a particular instance of time and compared the mean frequency to a higher threshold value to determine whether speech is detected. For example, if the mean frequency of the higher frequency band is lower than the higher threshold value for that frequency band, the audio data for that instance of time may be identified as having no voice activity (e.g., as being noise). In such an example, if the mean frequency of the higher frequency band is greater than the higher threshold value for that frequency band, the audio data for that instance of time may be identified as having voice activity.

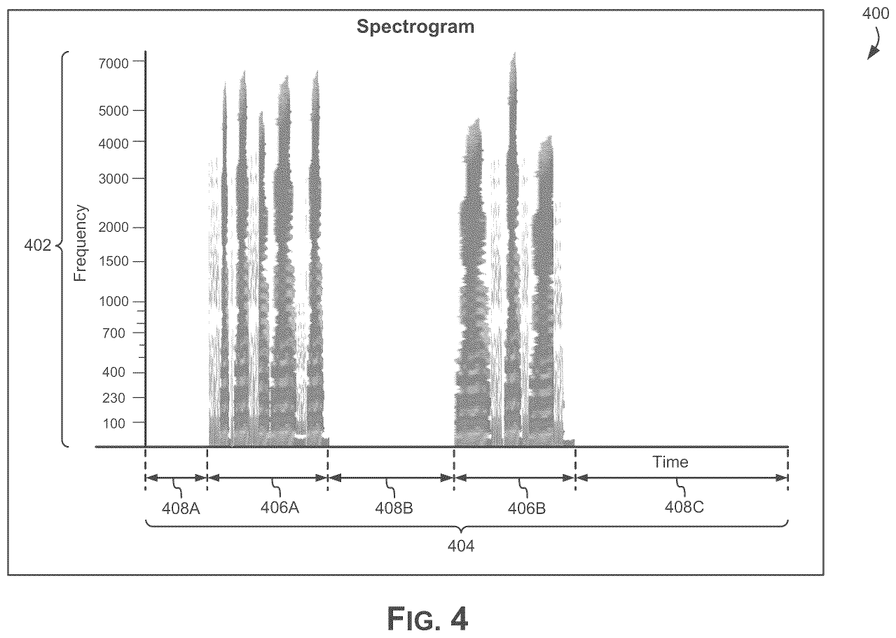

In at least one embodiment, if voice activity detector 140 identifies voice activity in the processed time-frequency representation of audio data for an instance of time at one or more frequencies of a frequency spectrum (e.g., in one or more frequency bands), voice activity detector 140 may retain, or otherwise preserve, the audio data associated with the corresponding frequencies. In at least one embodiment, if voice activity detector 140 does not identify voice activity in a time-frequency representation of audio data for an instance of time at one or more frequencies of a frequency spectrum (e.g., in one or more frequency bands), the audio data associated with the corresponding frequencies (e.g., the data associated with the corresponding frequency bins) may be reduced and/or removed (e.g., value modified to 0) to generate an updated spectrogram (e.g., spectrogram 400 of FIG. 4) with noise excluded and/or removed.

Time-frequency converter 150 may include one or more components to convert a spectrogram representing audio data to a time domain signal. In at least one embodiment, once an updated spectrogram has been generated by voice activity detector 140, time-frequency converter 150 may convert the updated spectrogram to a time domain signal. In at least one embodiment, time-frequency converter 150 may use an inverse Fourier transform (e.g., an inverse short-term Fourier transform (“ISTFT”)) to convert the updated spectrogram to the time domain. In at least one embodiment, time-frequency converter 150 may use an inverse Fourier transform that is modified to support input data arriving in a streaming fashion. For example, time-frequency converter 150 may use one or more overlapping segments (e.g., four segments of 512 samples) of audio data in a similar format and/or organization to that used by feature extractor 110. In at least one embodiment, a buffer is maintained with one or more past time segments or bands (e.g., three) that may be used by time-frequency converter 150 in conjunction with a current time band to compute a time domain representation of a denoised audio segment that includes clean speech.

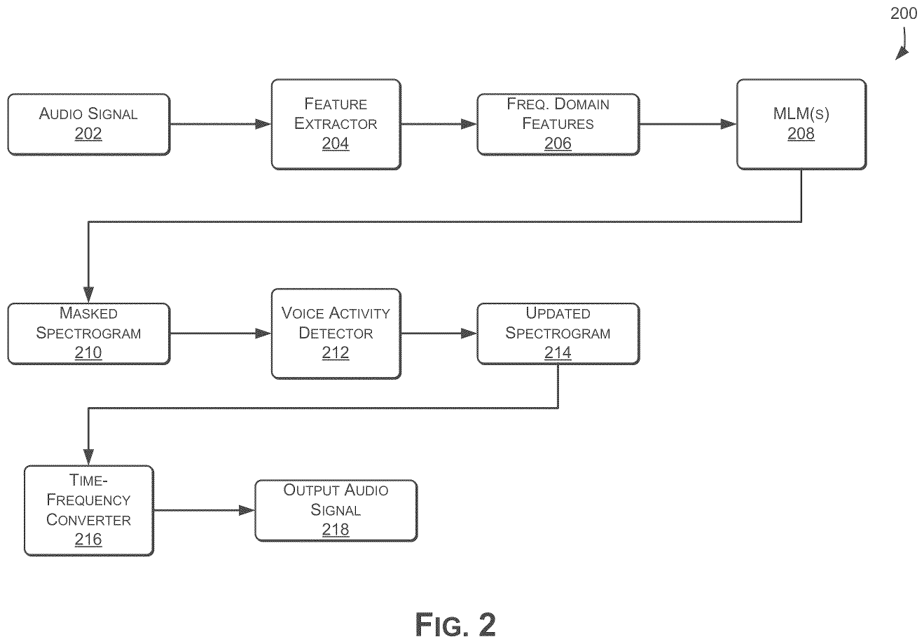

Now referring to FIG. 2, FIG. 2 is a diagram showing an example process 200 for noise reduction, in accordance with some embodiments of the present disclosure. It should be understood that this and other arrangements described herein are set forth only as examples. In some embodiments, an audio signal 202 may be provided to a feature extractor 204 (e.g., feature extractor 110 of FIG. 1). For example, audio signal 202 may be a stream of audio data captured using one or more microphones (e.g., by audio application 112 using input device(s) 114 of FIG. 1).

In some embodiments, feature extractor 204 may extract one or more frequency domain features 206 from audio signal 202. For example, feature extractor 204 may extract features from audio data to be represented as a mel-frequency spectrogram. In at least one embodiment, frequency domain features 206 may be provided to one or more machine learning model(s) 208 (e.g., machine learning model(s) 120 of FIG. 1). In some embodiments, machine learning model(s) 208 receive frequency domain features 206 as input to generate a masked spectrogram 210 (e.g., noisy audio spectrogram 300 of FIG. 3) as an output. For example, machine learning model(s) 208 may be trained to generate a noise mask that can be applied to audio signal 202 to be used to generate masked spectrogram 210.

In at least one embodiment, masked spectrogram 210 may be provided to a voice activity detector 212 (e.g., voice activity detector 140 of FIG. 1). In some examples, voice activity detector 212 may analyze one or more frequency bands and/or frequency ranges to identify portions of masked spectrogram 210 than include voice activity and/or do not include voice activity. In at least one embodiment, based on voice activity detector 212 identifying one or more portions of masked spectrogram 210 that include voice activity and/or do not include voice activity, an updated (denoised) spectrogram 214 (e.g., spectrogram 400 of FIG. 4) may be generated. For example, updated spectrogram 214 may be generated to preserve portions of audio identified by voice activity detector 212 as including voice activity, or being otherwise desirable, while removing or reducing portions of audio identified as not including voice activity, or being otherwise undesirable. In at least one embodiment, updated spectrogram 214 may be provided to a time-frequency converter 216 (e.g., time-frequency converter 150 of FIG. 1).

In at least one embodiment, time-frequency converter 216 may access updated spectrogram 214 as an input to generate an output audio signal 218. For example, time-frequency converter 216 may use an Inverse Fast Fourier Transform (“IFFT”) to convert updated spectrogram 214 to a time domain to generate output audio signal 218. In some embodiments, output audio signal 218 may be provided to a recipient device to cause presentation thereby of the output audio signal 218 (e.g., by playback application 118 and/or output device(s) 116 of FIG. 1).

Now referring to FIG. 3, FIG. 3 is a diagram showing an example of a noisy audio spectrogram 300, in accordance with some embodiments of the present disclosure. In at least one embodiment, noisy audio spectrogram 300 (or “spectrogram 300”) may be a time-frequency representation of an audio signal. For example, spectrogram 300 may indicate one or more properties (e.g., sound pressure, intensity, audio signal power, and/or the like) of the audio signal for a frequency range 302 over a period of time 304. The property(ies) may include one or more frequency domain features 206 (see FIG. 2) and/or parameter values extracted by a feature extractor (e.g., feature extractor 110 illustrated in FIG. 1, feature extractor 204 illustrated in FIG. 2, and/or the like) that were used to obtain frequency domain features 206. In at least one embodiment, spectrogram 300 may include representation of desirable audio, such as audio with voice activity 306, and/or undesired audio, such as audio without voice activity 308.

In at least one embodiment, identifying portions of spectrogram 300 that include audio with voice activity 306 and/or audio without voice activity 308, may include using a voice activity detector, such as voice activity detector 140 of FIG. 1 and/or voice activity detector 212 of FIG. 2. In at least one embodiment, a voice activity detector may analyze any number of frequency bands in frequency range 302. For example, a voice activity detector may analyze a higher frequency band 310 and/or a lower frequency band 320. In at least one embodiment, a voice activity detector may determine a frequency associated with a frequency band, to compare to a threshold value corresponding to that frequency band. By way of non-limiting examples, the calculated frequency for a particular frequency band may calculated (e.g., a mean, a median, a mode, and/or the like) based the property(ies) (e.g., sound pressure, intensity, audio signal power, and/or the like) associated with the frequencies of the particular frequency band. The property(ies) may include frequency domain features 206 (see FIG. 2) and/or parameter values extracted by a feature extractor (e.g., feature extractor 110 illustrated in FIG. 1, feature extractor 204 illustrated in FIG. 2, and/or the like) that were used to obtain frequency domain features 206. For example, a voice activity detector may calculate a first (higher) mean frequency 312 of the higher frequency band 310 and/or a second (lower) mean frequency 322 of the lower frequency band 320 based on the sound pressure, intensity, and/or audio signal power associated with the frequencies of each respective frequency band that is analyzed. In some examples, a voice activity detector will compare one or more calculated frequencies to one or more threshold values to identify voice activity. For example, a voice activity detector may compare a second (lower) mean frequency 322 of the lower frequency band 320 to a second (lower) threshold value associated with the lower frequency band 320. In such an example, if the second (lower) mean frequency 322 satisfies the second (lower) threshold value, the voice activity detector will identify the corresponding interval of time as audio that includes voice activity 306. In another example, if the first (higher) mean frequency 312 satisfies a first (higher) threshold value associated with the higher frequency band 310, the voice activity detector will identify the corresponding interval of time as audio that includes voice activity 306. In at least one embodiment, if a calculated frequency, such as mean frequency 312 and/or mean frequency 322, does not satisfy a threshold value associated with a frequency band for which the calculated frequency was calculated, the voice activity detector will identify the corresponding interval of time as audio without voice activity 308.

Now referring to FIG. 4, FIG. 4 is a diagram showing an example of denoised spectrogram 400, in accordance with some embodiments of the present disclosure. In at least one embodiment, denoised spectrogram 400 (or “spectrogram 400”) may be a time-frequency representation of an audio signal. For example, spectrogram 400 may indicate one or more properties (e.g., sound pressure, intensity, and/or audio signal power) of the audio signal for a frequency range 402 over a period of time 404. In at least one embodiment, spectrogram 400 may include representation of desirable audio, such as audio with voice activity, and/or undesired audio, such as audio without voice activity. In at least one embodiment, spectrogram 400 includes audio data from spectrogram 300 of FIG. 3 after undergoing denoising and/or noise reduction operations. For example, spectrogram 400 includes portions 406A and 406B of audio data that are identified by a voice activity detector as audio with voice activity (e.g., voice activity 306 illustrated in FIG. 3), while portions of audio data that were identified by the voice activity detector as audio without voice activity (e.g., audio without voice activity 308 illustrated in FIG. 3) have been excluded, reduced, and/or removed, leaving portions 408A-408C of spectrogram 400 that represent reduced sound and/or silence.

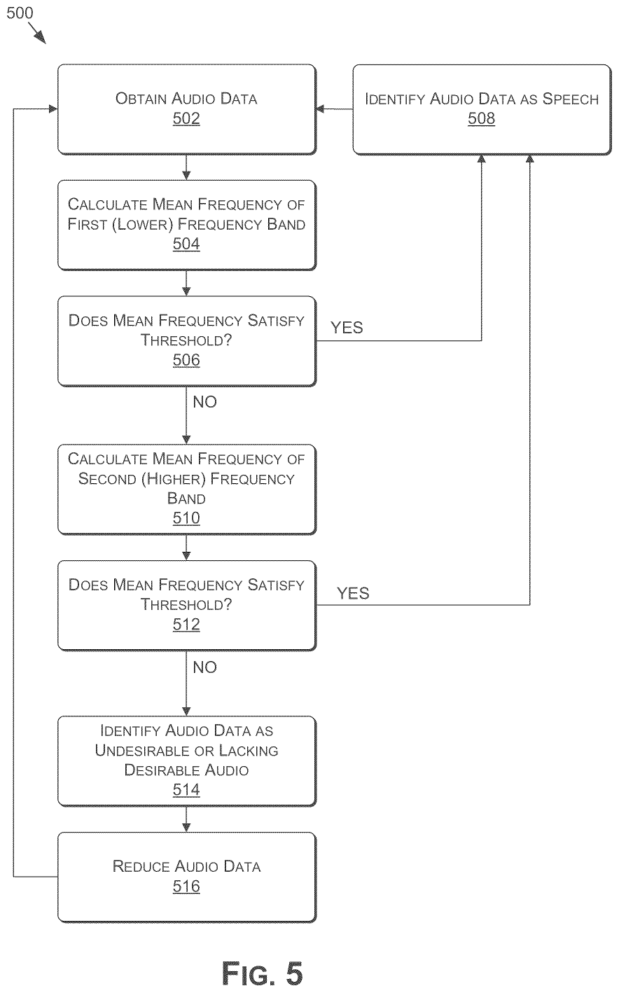

Now referring to FIG. 5, each block of a method 500, described herein, includes a computing process that may be performed using any combination of hardware, firmware, and/or software. For instance, various functions may be carried out by a processor executing instructions stored in memory. Method 500 may also be embodied as computer-usable instructions stored on computer storage media. Method 500 may be provided by a standalone application, a service or hosted service (standalone or in combination with another hosted service), or a plug-in to another product, to name a few. In addition, method 500 is described, by way of example, with respect to system 100 of FIG. 1. However, method 500 may additionally or alternatively be executed by any one system, or any combination of systems, including, but not limited to, those described herein.

FIG. 5 is a flow diagram showing method 500 for performing a multi-band voice detection operation, in accordance with some embodiments of the present disclosure. By way of a non-limiting example, method 500 may be performed at least in part by voice activity detector 140 (see FIG. 1). Method 500, at 502, includes obtaining audio data. For example, voice activity detector 140 may obtain a time-frequency representation of audio data that is output from machine learning model(s) 120 as a spectrogram (e.g., masked spectrogram 210 illustrated in FIG. 2, noisy audio spectrogram 300 illustrated in FIG. 3, and/or the like). Method 500, at 504 includes calculating a mean frequency corresponding to the obtained audio data that is within a first frequency band. For example, voice activity detector 140 may analyze a first (lower) band of a spectrogram associated with the audio data obtained at 502 to calculate a mean frequency for the first frequency band. Method 500, at 506 includes determining whether the mean frequency for the first frequency band calculated at 504, satisfies a threshold value for the first frequency band. In at least one embodiment, if the mean frequency satisfies a threshold value, method 500 at 508, may include identifying the audio data as speech. In at least one embodiment, if the mean frequency does not satisfy the threshold value, method 500 at 510, may include calculating a mean frequency corresponding to the obtained audio data that is within a second frequency band. For example, voice activity detector 140 may analyze a second (lower) band of a spectrogram associated with the audio data obtained at 502 to calculate a mean frequency for the second frequency band. Method 500, at 512 includes determining whether the mean frequency for the second frequency band calculated at 510, satisfies a threshold value for the second frequency band. In at least one embodiment, if the mean frequency for the second frequency band, calculated at 510, satisfies a threshold value, method 500 at 508, may include identifying the audio data as speech. In at least one embodiment, if the mean frequency for the second frequency band, calculated at 510, does not satisfy the threshold value, method 500 at 514, may include identifying the audio data as undesirable and/or lacking desirable audio. Method 500, at 516 may include reducing (e.g., or removing) at least a portion of the audio data obtained at 502. In at least one embodiment, new audio data may be obtained (e.g., at 502) and method 500 may repeat for one or more cycles. In at least one embodiment, after block 516, method 500 may terminate.

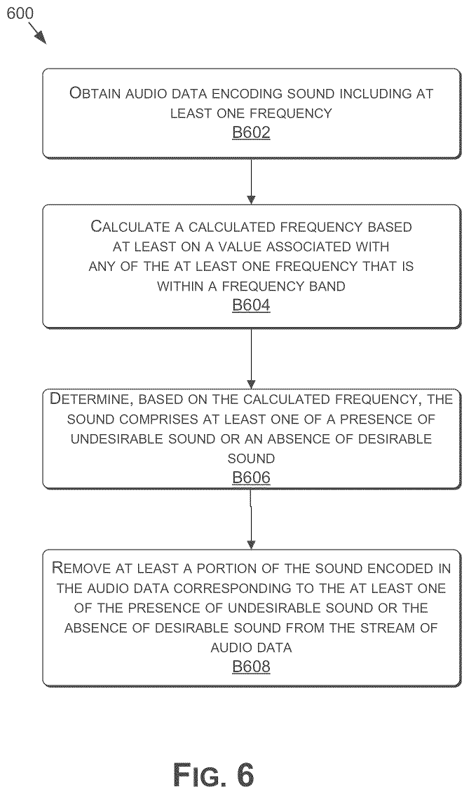

Now referring to FIG. 6, each block of a method 600, described herein, includes a computing process that may be performed using any combination of hardware, firmware, and/or software. For instance, various functions may be carried out by a processor executing instructions stored in memory. Method 600 may also be embodied as computer-usable instructions stored on computer storage media. Method 600 may be provided by a standalone application, a service or hosted service (standalone or in combination with another hosted service), or a plug-in to another product, to name a few. In addition, method 600 is described, by way of example, with respect to system 100 of FIG. 1. However, method 600 may additionally or alternatively be executed by any one system, or any combination of systems, including, but not limited to, those described herein.

FIG. 6 is a flow diagram showing method 600 for performing a voice detection operation, in accordance with some embodiments of the present disclosure. By way of a non-limiting example, method 600 may be performed at least in part by voice activity detector 140 (see FIG. 1). Method 600, at block B602, includes obtaining audio data encoding sound including at least one frequency. For example, voice activity detector 140 may obtain a time-frequency representation of audio data that is output from machine learning model(s) 120 as a spectrogram (e.g., masked spectrogram 210 illustrated in FIG. 2, noisy audio spectrogram 300 illustrated in FIG. 3, and/or the like). Method 600, at block B604 includes calculating a calculated frequency based at least in part on a value associated with any of the at least one frequency that is within a frequency band. For example, voice activity detector 140 may analyze one or more frequency bands of the spectrogram obtained at block B602 to calculate a mean frequency for the one or more frequency bands. Method 600, at block B606 includes determining, based on the calculated frequency, the sound comprises at least one of a presence of undesirable sound or an absence of desirable sound. For example, voice activity detector 140 may determine that the audio data obtained at block B602 lacks desirable sound and/or includes undesirable sound. Method 600, at block B608 includes removing at least a portion of the sound encoded in the audio data corresponding to the at least one of the presence of undesirable sound or the absence of desirable sound from the stream of audio data. For example, voice activity detector 140 may remove portions of the sound data obtained block B602 that comprise an absence of desirable sound and/or presence of undesirable sound. After block B608, method 600 may terminate.

The systems and methods described herein may be used by, without limitation, non-autonomous vehicles, semi-autonomous vehicles (e.g., in one or more adaptive driver assistance systems (ADAS), or one or more in-vehicle infotainment (IVI) systems), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. The systems and methods described herein may be used in augmented reality, virtual reality, mixed reality, robotics, security and surveillance, autonomous or semi-autonomous machine applications, and/or any other technology spaces where noise reduction may be used.

The systems and methods described herein may be used by, without limitation, non-autonomous vehicles, semi-autonomous vehicles (e.g., in one or more ADAS or IVI systems), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Game Streaming System

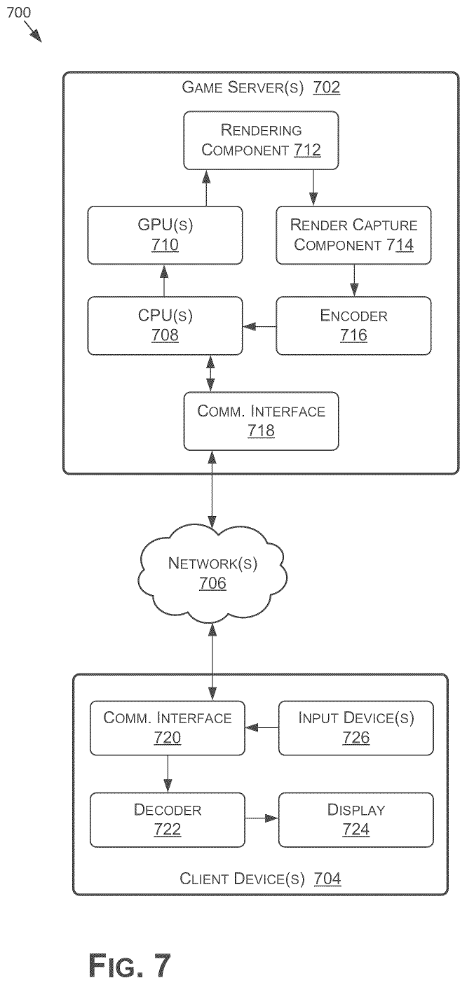

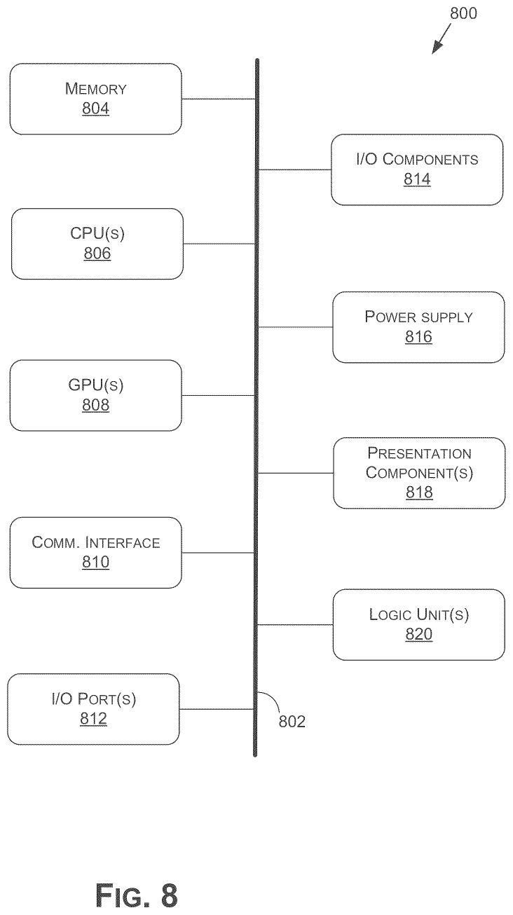

Now referring to FIG. 7, FIG. 7 is an example system diagram for a game streaming system 7700, in accordance with some embodiments of the present disclosure. FIG. 7 includes game server(s) 702 (which may include similar components, features, and/or functionality to the example computing device 800 of FIG. 8), client device(s) 704 (which may include similar components, features, and/or functionality to the example computing device 800 of FIG. 8), and network(s) 706 (which may be similar to the network(s) described herein). In some embodiments of the present disclosure, the system 700 may be implemented.

In the system 700, for a game session, the client device(s) 704 may only receive input data in response to inputs to the input device(s), transmit the input data to the game server(s) 702, receive encoded display data from the game server(s) 702, and display the display data on the display 724. As such, the more computationally intense computing and processing is offloaded to the game server(s) 702 (e.g., rendering—in particular ray or path tracing—for graphical output of the game session is executed by the GPU(s) of the game server(s) 702). In other words, the game session is streamed to the client device(s) 704 from the game server(s) 702, thereby reducing the requirements of the client device(s) 704 for graphics processing and rendering.

For example, with respect to an instantiation of a game session, a client device 704 may be displaying a frame of the game session on the display 724 based on receiving the display data from the game server(s) 702. The client device 704 may receive an input to one of the input device(s) and generate input data in response. The client device 704 may transmit the input data to the game server(s) 702 via the communication interface 720 and over the network(s) 706 (e.g., the Internet), and the game server(s) 702 may receive the input data via the communication interface 718. The CPU(s) may receive the input data, process the input data, and transmit data to the GPU(s) that causes the GPU(s) to generate a rendering of the game session. For example, the input data may be representative of a movement of a character of the user in a game, firing a weapon, reloading, passing a ball, turning a vehicle, etc. The rendering component 712 may render the game session (e.g., representative of the result of the input data) and the render capture component 714 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the game server(s) 702. The encoder 716 may then encode the display data to generate encoded display data and the encoded display data may be transmitted to the client device 704 over the network(s) 706 via the communication interface 718. The client device 704 may receive the encoded display data via the communication interface 720 and the decoder 722 may decode the encoded display data to generate the display data. The client device 704 may then display the display data via the display 724.

In at least one embodiment, at least one component shown or described with respect to FIG. 7 is utilized to implement techniques and/or functions described in connection with FIGS. 1-6. In at least one embodiment, at least one component shown or described with respect to FIG. 7 is used to analyze audio, detect speech, and/or identify audio with undesirable sound and/or lacking desirable sound. In at least one embodiment, at least one component shown or described with respect to FIG. 7 performs at least one aspect described with respect to processor 160, feature extractor 110, audio application 112, machine learning model(s) 120, post-processor 130, voice activity detector 140, time-frequency converter 150, and/or playback application 118 of FIG. 1, feature extractor 204, MLM(s) 208, voice activity detector 212, and/or time-frequency converter 216 of FIG. 2, spectrogram 300 of FIG. 3, denoised spectrogram 400 of FIG. 4, method 500 of FIG. 5, and/or method 600 of FIG. 6.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may include computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not include signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, etc.), and output the data (e.g., as an image, video, sound, etc.).

In at least one embodiment, at least one component shown or described with respect to FIG. 8 is utilized to implement techniques and/or functions described in connection with FIGS. 1-6. In at least one embodiment, at least one component shown or described with respect to FIG. 8 is used to analyze audio, detect speech, and/or identify audio with undesirable sound and/or lacking desirable sound. In at least one embodiment, at least one component shown or described with respect to FIG. 8 performs at least one aspect described with respect to processor 160, feature extractor 110, audio application 112, machine learning model(s) 120, post-processor 130, voice activity detector 140, time-frequency converter 150, and/or playback application 118 of FIG. 1, feature extractor 204, MLM(s) 208, voice activity detector 212, and/or time-frequency converter 216 of FIG. 2, spectrogram 300 of FIG. 3, denoised spectrogram 400 of FIG. 4, method 500 of FIG. 5, and/or method 600 of FIG. 6.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

At least one embodiment of the disclosure can be described in view of the following clauses:
1. A method comprising: obtaining audio data encoding sound comprising at least one frequency; calculating a calculated frequency based at least on a value associated with any of the at least one frequency that is within a frequency band; determining, based on the calculated frequency, the sound comprises at least one of a presence of undesirable sound or an absence of desirable sound; and removing at least a portion of the sound encoded in the audio data corresponding to the at least one of the presence of undesirable sound or the absence of desirable sound from a stream of audio data.
2. The method of clause 1, wherein obtaining the audio data comprises obtaining the audio data from the stream of audio data.
3. The method of clause 1 or 2, further comprising: adjusting a sound value associated with at least a portion of the at least one frequency after determining the sound comprises at least one the presence of undesirable sound or the absence of desirable sound.
4. The method of any one of clauses 1-3, wherein the value corresponds to an intensity value, and the calculated frequency is a mean frequency calculated based at least in part on the intensity value associated with any of the at least one frequency that is within the frequency band.
5. The method of any one of clauses 1-4, wherein determining the sound comprises at least one of a presence of undesirable sound or an absence of desirable sound comprises comparing the calculated frequency to a threshold value.
6 The method of any one of clauses 1-3, wherein the calculated frequency is a first calculated frequency, the frequency band is a first frequency band, determining the sound comprises at least one of the presence of undesirable sound or the absence of desirable sound comprises calculating a second calculated frequency based at least on the value associated with any of the at least one frequency that is within a second frequency band, and the second frequency band is different from the first frequency band.
7. The method of any one of clauses 1-6, wherein the second frequency band comprises one or more frequencies greater than the first frequency band.
8. The method of any one of clauses 1-7, wherein the desirable sound corresponds to a unit of human speech, the first frequency band corresponds to a first portion of the unit of human speech, and the second frequency band corresponds to a different second portion of the unit of human speech.
9. The method of any one of clauses 1-8, wherein determining the sound comprises at least one of a presence of undesirable sound or an absence of desirable sound comprises: comparing the first calculated frequency to a first threshold value; and comparing the second calculated frequency to a second threshold value.
10. The method of any one of clauses 1-9, wherein: the audio data is generated using one or more neural networks, the audio data comprising a time-frequency representation of an audio signal.
11. The method of any one of clauses 1-10, further comprising: presenting an audio stream that excludes at least a portion of the sound encoded in the audio data.
12. A processor comprising one or more processing units to perform operations comprising: determining at least one frequency for a segment of an audio signal based at least on one or more values associated with one or more frequencies within one or more frequency bands; and removing at least a portion of the segment from the audio signal when the at least one frequency indicates the segment comprises at least one of a presence of undesirable sound or an absence of desirable sound.
13. The processor of clause 12, wherein the audio signal is a streaming audio signal, and the operations further comprise: obtaining the segment from the streaming audio signal.
14. The processor of clause 12 or 13, wherein the one or more values include one or more intensity values, and the at least one frequency comprises a mean frequency calculated based at least on any of the one or more intensity values associated with any of the one or more frequencies within a particular one of the one or more frequency bands.
15. The processor of any one of clauses 12-14, wherein the at least one frequency comprises a first frequency and a second frequency, a first frequency of the at least one frequency is determined based at least on any of the one or more values associated with any of the one or more frequencies within a first frequency band of the one or more frequency bands; a second frequency of the at least one frequency is determined based at least on any of the one or more values associated with any of the one or more frequencies within a second frequency band of the one or more frequency bands; and the second frequency band is different from the first frequency band.
16. The processor of any one of clauses 12-15, wherein the operations further comprise: determining the at least one frequency indicates the segment comprises at least one of the presence of undesirable sound or the absence of desirable sound by comparing the first frequency to a first threshold value, and comparing the second frequency to a second threshold value.
17. The processor of any one of clauses 12-16, wherein the desirable sound comprises a unit of human speech, the first frequency band corresponds to a first portion of the unit of human speech, and the second frequency band corresponds to a different second portion of the unit of human speech.
18. A system comprising: one or more processing units to remove sound from at least one particular segment of one or more segments of an audio signal when at least one frequency, determined for at least one frequency band and the at least one particular segment, indicates the at least one particular segment comprises at least one of a presence of undesirable sound or an absence of desirable sound.
19. The system of clause 18, wherein the at least one frequency comprises a first frequency and a second frequency, the at least one frequency band comprises a first frequency band and a second frequency band, the second frequency band is different from the first frequency band, and the one or more processing units are further to: calculate the first frequency based at least on one or more values associated with the at least one particular segment and any frequency within the first frequency band; and calculate the second frequency based at least on one or more values associated with the at least one particular segment and any frequency within the second frequency band.
20. The system of clause 18 or 19, wherein the one or more processing units are further to determine the at least one frequency indicates the at least one particular segment comprises at least one of a presence of undesirable sound or an absence of desirable sound by comparing the first frequency to a first threshold value, and comparing the second frequency to a second threshold value.
21. The system of any one of clauses 18-20, wherein the at least one frequency comprises a mean frequency calculated based at least on one or more intensity values associated with any frequency within a particular one of the at least one frequency band.
22. The system of any one of clauses 18-21, wherein the one or more processing units are further to present an audio stream that excludes the sound.
23. The system of any one of clauses 18-22, wherein the system is comprised in at least one of: a control system for an autonomous or semi-autonomous machine; a perception system for an autonomous or semi-autonomous machine; an in-vehicle infotainment system for an autonomous or semi-autonomous machine; a first system for performing simulation operations; a second system for performing digital twin operations; a third system for performing light transport simulation; a fourth system for performing collaborative content creation for 3D assets; a fifth system for performing deep learning operations; a sixth system implemented using an edge device; a seventh system implemented using a robot; an eighth system for performing conversational Artificial Intelligence operations; a ninth system for generating synthetic data; a tenth system incorporating one or more virtual machines (VMs); an eleventh system implemented at least partially in a data center; or a twelfth system implemented at least partially using cloud computing resources.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
obtaining audio data encoding sound comprising at least one frequency;
calculating a calculated frequency based at least on a value associated with any of the at least one frequency that is within a frequency band;
determining, based on the calculated frequency, the sound comprises at least one of a presence of undesirable sound or an absence of desirable sound; and
removing at least a portion of the sound encoded in the audio data corresponding to the at least one of the presence of undesirable sound or the absence of desirable sound from a stream of audio data.

2. The method of claim 1, further comprising:
adjusting a sound value associated with at least a portion of the at least one frequency after determining the sound comprises at least one the presence of undesirable sound or the absence of desirable sound.

3. The method of claim 1, wherein the value corresponds to an intensity value, and
the calculated frequency is a mean frequency calculated based at least in part on the intensity value associated with any of the at least one frequency that is within the frequency band.

4. The method of claim 1, wherein determining the sound comprises at least one of a presence of undesirable sound or an absence of desirable sound comprises comparing the calculated frequency to a threshold value.

5. The method of claim 1, wherein the calculated frequency is a first calculated frequency,
the frequency band is a first frequency band,
determining the sound comprises at least one of the presence of undesirable sound or the absence of desirable sound comprises calculating a second calculated frequency based at least on the value associated with any of the at least one frequency that is within a second frequency band, and
the second frequency band is different from the first frequency band.

6. The method of claim 5, wherein the second frequency band comprises one or more frequencies greater than the first frequency band.

7. The method of claim 6, wherein the desirable sound corresponds to a unit of human speech,
the first frequency band corresponds to a first portion of the unit of human speech, and
the second frequency band corresponds to a different second portion of the unit of human speech.

8. The method of claim 5, wherein determining the sound comprises at least one of a presence of undesirable sound or an absence of desirable sound comprises:
comparing the first calculated frequency to a first threshold value; and
comparing the second calculated frequency to a second threshold value.

9. The method of claim 1, wherein:
the audio data is generated using one or more neural networks, the audio data comprising a time-frequency representation of an audio signal.

10. The method of claim 1, further comprising:
presenting an audio stream that excludes at least a portion of the sound encoded in the audio data.

11. A processor comprising one or more processing units to perform operations comprising:
determining at least one frequency for a segment of an audio signal based at least on one or more values associated with one or more frequencies within one or more frequency bands; and
removing at least a portion of the segment from the audio signal when the at least one frequency indicates the segment comprises at least one of a presence of undesirable sound or an absence of desirable sound.

12. The processor of claim 11, wherein the audio signal is a streaming audio signal, and the operations further comprise:
obtaining the segment from the streaming audio signal.

13. The processor of claim 11, wherein the one or more values include one or more intensity values, and
the at least one frequency comprises a mean frequency calculated based at least on any of the one or more intensity values associated with any of the one or more frequencies within a particular one of the one or more frequency bands.

14. The processor of claim 11, wherein the at least one frequency comprises a first frequency and a second frequency,
a first frequency of the at least one frequency is determined based at least on any of the one or more values associated with any of the one or more frequencies within a first frequency band of the one or more frequency bands;
a second frequency of the at least one frequency is determined based at least on any of the one or more values associated with any of the one or more frequencies within a second frequency band of the one or more frequency bands; and
the second frequency band is different from the first frequency band.

15. The processor of claim 14, wherein the operations further comprise:
determining the at least one frequency indicates the segment comprises at least one of the presence of undesirable sound or the absence of desirable sound by comparing the first frequency to a first threshold value, and comparing the second frequency to a second threshold value.

16. The processor of claim 15, wherein the desirable sound comprises a unit of human speech,
the first frequency band corresponds to a first portion of the unit of human speech, and
the second frequency band corresponds to a different second portion of the unit of human speech.

17. A system comprising:
one or more processing units to remove sound from at least one particular segment of one or more segments of an audio signal when at least one frequency, determined for at least one frequency band and the at least one particular segment, indicates the at least one particular segment comprises at least one of a presence of undesirable sound or an absence of desirable sound.

18. The system of claim 17, wherein the at least one frequency comprises a first frequency and a second frequency,
the at least one frequency band comprises a first frequency band and a second frequency band,
the second frequency band is different from the first frequency band, and
the one or more processing units are further to:
calculate the first frequency based at least on one or more values associated with the at least one particular segment and any frequency within the first frequency band; and
calculate the second frequency based at least on one or more values associated with the at least one particular segment and any frequency within the second frequency band.

19. The system of claim 18, wherein the one or more processing units are further to determine the at least one frequency indicates the at least one particular segment comprises at least one of a presence of undesirable sound or an absence of desirable sound by comparing the first frequency to a first threshold value, and comparing the second frequency to a second threshold value.

20. The system of claim 17, wherein the system is comprised in at least one of:
a control system for an autonomous or semi-autonomous machine;
a perception system for an autonomous or semi-autonomous machine;
an in-vehicle infotainment system for an autonomous or semi-autonomous machine;
a first system for performing simulation operations;
a second system for performing digital twin operations;
a third system for performing light transport simulation;
a fourth system for performing collaborative content creation for 3D assets;
a fifth system for performing deep learning operations;
a sixth system implemented using an edge device;
a seventh system implemented using a robot;
an eighth system for performing conversational Artificial Intelligence operations;
a ninth system for generating synthetic data;
a tenth system incorporating one or more virtual machines (VMs);
an eleventh system implemented at least partially in a data center; or
a twelfth system implemented at least partially using cloud computing resources.
